(19) United States
(12) Patent Application Publication
(10) Pub. No.: US 2026/0262016 A1
(43) Pub. Date: Sep. 3, 2026

(54) COMMUNICATION METHOD, COMMUNICATION DEVICE, AND RECORDING MEDIUM

(71) Applicant: Panasonic Intellectual Property Management Co., Ltd., Osaka (JP)

(72) Inventor: Mitsuhiro IMAO, Tokyo (JP)

(21) Appl. No.: 19/653,636

(22) Filed: Apr. 21, 2026

Related U.S. Application Data
(63) Continuation of application No. PCT/JP2024/037600, filed on Oct. 22, 2024.

(30) Foreign Application Priority Data
Nov. 2, 2023 (JP) 2023-188819

(51) Int. Cl. H04W 64/00; H04W 4/38

(52) U.S. Cl. CPC H04W 64/006; H04W 4/38

(57) ABSTRACT

A communication method for communicating to a first user includes: obtaining and storing second position information indicating a position of a second user different from the first user and activity information indicating an activity of the second user, the second position information and the activity information being stored in association with each other; generating, based on the activity information, data that reproduces an activity of the second user, the data being data that, when output to a stimulus presenter, presents a stimulus for reproducing and communicating the activity of the second user; and outputting, in a target space to which the position indicated in the second position information belongs, the data generated based on the activity information associated with the second position information, to the stimulus presenter.

### CROSS REFERENCE TO RELATED APPLICATIONS

This is a continuation application of PCT International Application No. PCT/JP2024/037600 filed on October 22, 2024, designating the United States of America, which is based on and claims priority of Japanese Patent Application No. 2023-188819 filed on November 2, 2023. The entire disclosures of the above-identified applications, including the specifications, drawings, and claims are incorporated herein by reference in their entirety.

### FIELD

The present disclosure relates to a communication method, a communication device, and a recording medium.

### BACKGROUND

Conventionally, users receive various communications based on information that the users desire. For example, Patent Literature (PTL) 1 discloses an information processing device capable of presenting a sense of presence of a virtual object in real space (in other words, communicating or reproducing the sense of presence).

### Citation List

### Patent Literature

PTL 1: International Publication No. WO 2016/185740

### SUMMARY

### Technical Problem

However, an information processing device such as that disclosed in PTL 1 is not appropriate for communication based on information about other actual users, because it only allows users to experience pre-created content. In view of this, the present disclosure has an object to provide a communication method and the like that enable more appropriate communication based on information about a user.

### Solution to Problem

A communication method according to one aspect of the present disclosure is a communication method for communicating to a first user, the communication method including: obtaining and storing second position information indicating a position of a second user different from the first user and activity information indicating an activity of the second user, the second position information and the activity information being stored in association with each other; generating, based on the activity information, data that reproduces the activity of the second user, the data being data that, when output to a stimulus presenter, presents a stimulus for reproducing and communicating the activity of the second user; and outputting, in a target space to which the position indicated in the second position information belongs, the data generated based on the activity information associated with the second position information, to the stimulus presenter.

A communication device according to one aspect of the present disclosure is a communication device for communicating to a first user, the communication device including: a storage controller that obtains second position information indicating a position of a second user different from the first user and activity information indicating an activity of the second user, and stores the second position information and the activity information in association with each other; a generator that generates, based on the activity information, data that reproduces the activity of the second user, the data being data that, when output to a stimulus presenter, presents a stimulus for reproducing and communicating the activity of the second user; and an outputter that outputs, in a target space to which the position indicated in the second position information belongs, the data generated based on the activity information associated with the second position information, to the stimulus presenter.

One aspect of the present disclosure may be realized as a non-transitory computer-readable recording medium for use in a computer, the recording medium having a computer program recorded thereon for causing the computer to execute a communication method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure enables more appropriate communication based on information about a user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining an example of use of a communication system according to an embodiment of the present disclosure.

FIG. 2 is a block diagram illustrating the functional configuration of a communication system according to an embodiment of the present disclosure.

FIG. 3 is a diagram illustrating an example of information stored in storage according to an embodiment of the present disclosure.

FIG. 4 illustrates an example of a database according to an embodiment of the present disclosure.

FIG. 5 is a flowchart illustrating an operation example of a communication device according to an embodiment of the present disclosure.

### DESCRIPTION OF EMBODIMENTS

### Underlying Knowledge Forming Basis of the Disclosure

Conventionally, users receive various communications based on information that the users desire. For example, according to the information processing device disclosed in PTL 1, it is possible to present a sense of presence of a virtual object in real space. Stated differently, it is possible to communicate by perceiving a virtual object as if the object actually exists in real space. However, an information processing device such as that disclosed in PTL 1 allows users to experience a sense of presence of a virtual object as pre-created content, but such content is not appropriate for experiencing other actual users as virtual objects. Stated differently, conventional information processing devices are not appropriate for communication based on information about other actual users.

In view of this, the present disclosure, as more appropriate communication based on information about a user, automatically determines a stimulus to be presented for communication from an activity performed by another actual user in order to realize the communication, and presents the determined stimulus to the user. By doing so, the user can perceive an activity performed by another actual user. As a result, communication can be made from the other user to the one user according to the situation of the other user, making it possible to use this as a new form of communication for communicating. The present disclosure describes a communication method and the like that makes communication from the other user to the one user according to the situation of the other user.

More specifically, a communication method according to a first aspect of the present disclosure is a communication method for communicating to a first user, the communication method including: obtaining and storing second position information indicating a position of a second user different from the first user and activity information indicating an activity of the second user, the second position information and the activity information being stored in association with each other; generating, based on the activity information, data that reproduces an activity of the second user, the data being data that, when output to a stimulus presenter, presents a stimulus for reproducing and communicating the activity of the second user; and outputting, in a target space to which the position indicated in the second position information belongs, the data generated based on the activity information associated with the second position information, to the stimulus presenter.

According to such a communication method, communication can be made from the second user to the first user through communication in which the activity is reproduced, even without direct contact from the second user to the first user. Therefore, the first user can perceive the situation of the second user through the presented stimulus that indicates the activity reproduced for communication. This enables more appropriate communication based on information about the user.

For example, a communication method according to a second aspect of the present disclosure is the communication method according to the first aspect, further including: obtaining first position information indicating a position of the first user, wherein the outputting is executed when the position indicated in the first position information becomes a position that belongs to the target space.

With this, when the first user moves to the target space, the first user can perceive an activity that the second user performed, or will perform in the future, in the target space.

For example, a communication method according to a third aspect of the present disclosure is the communication method according to the first or second aspect, wherein the outputting is executed at a set time set in advance by the second user.

With this, the first user can perceive an activity that the second user performed, or will perform in the future, at a set time preset by the second user.

For example, a communication method according to a fourth aspect of the present disclosure is the communication method according to any one of the first to third aspects, wherein the obtaining and storing includes obtaining, in addition to the second position information and the activity information, a time of obtainment of the second position information and the activity information, and storing the second position information, the activity information, and the time in association with each other.

With this, time information can be used in generating and outputting data.

For example, a communication method according to a fifth aspect of the present disclosure is the communication method according to the fourth aspect, further including: obtaining a specified time specified by the first user, wherein the outputting includes: outputting, to the stimulus presenter, the data generated based on the activity information associated with the time corresponding to the specified time; and excluding, from output to the stimulus presenter, the data generated based on the activity information associated with the time not corresponding to the specified time. With this, an activity of the second user at a time corresponding to the specified time specified by the first user can be reproduced. Stated differently, the first user can select and reproduce a portion in time series from among activities of the second user.

For example, a communication method according to a sixth aspect of the present disclosure is the communication method according to any one of the first to fifth aspects, wherein the data is associated with a type of stimulus to be presented when output to the stimulus presenter, and the outputting includes simultaneously outputting a plurality of items of the data generated based on a same item of the activity information, the plurality of items of the data being associated with different types of stimuli to be presented when output to the stimulus presenter.

With this, communication of the same activity can be reproduced by presenting a plurality of stimuli of different types. Even if the stimulus to be presented for communication is abstracted, an activity can be reproduced with a greater sense of realism by a plurality of types of stimuli.

For example, a communication method according to a seventh aspect of the present disclosure is the communication method according to any one of the first to sixth aspects, wherein the data is data that, when output to the stimulus presenter, presents the stimulus for reproducing a future activity of the second user.

With this, the first user can perceive an activity that the second user will perform in the future.

For example, a communication method according to an eighth aspect of the present disclosure is the communication method according to any one of the first to seventh aspects, wherein the data is data that, when output to the stimulus presenter, presents the stimulus for reproducing a past activity of the second user.

With this, the first user can perceive an activity that the second user performed.

For example, a communication method according to a ninth aspect of the present disclosure is the communication method according to any one of the first to eighth aspects, wherein the generating includes generating the data based on the activity information by referencing a database that associates the activity information with the data using the activity information.

With this, by referencing the database, data based on the activity information can be generated.

For example, a communication method according to a tenth aspect of the present disclosure is the communication method according to any one of the first to ninth aspects, wherein in the outputting, the stimulus is presented from the stimulus presenter using a virtual character that is an abstraction of the second user.

With this, the first user can perceive an activity that the second user performed, or will perform in the future, using a virtual character that is an abstraction of the second user.

For example, a communication method according to an eleventh aspect of the present disclosure is the communication method according to any one of the first to tenth aspects, wherein the generating includes generating the data that, when output to the stimulus presenter, reproduces the stimulus generated by an operation of a device related to an activity indicated in the activity information.

With this, a stimulus generated by an operation of a device related to an activity of the second user can be reproduced.

For example, a communication method according to a twelfth aspect of the present disclosure is the communication method according to any one of the first to eleventh aspects, wherein the activity information includes at least one of vital information indicating a vital sign of the second user or motion information indicating a motion of the second user.

With this, at least one of vital information indicating a vital sign of the second user or motion information indicating a motion of the second user can be used in generating and outputting data.

For example, a communication device according to a thirteenth aspect of the present disclosure is a communication device for communicating to a first user, the communication device including: a storage controller that obtains second position information indicating a position of a second user different from the first user and activity information indicating an activity of the second user, and stores the second position information and the activity information in association with each other; a generator that generates, based on the activity information, data that reproduces the activity of the second user, the data being data that, when output to a stimulus presenter, presents a stimulus for reproducing and communicating the activity of the second user; and an outputter that outputs, in a target space to which the position indicated in the second position information belongs, the data generated based on the activity information associated with the second position information, to the stimulus presenter.

With this, the same effects as the communication method described above can be achieved.

For example, a recording medium according to a fourteenth aspect of the present disclosure is a non-transitory computer-readable recording medium for use in a computer, the recording medium having a computer program recorded thereon for causing the computer to execute the communication method according to any one of the first to twelfth aspects.

With this, by executing the computer program using a computer, the same effects as the communication method described above are achieved.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments of the present disclosure will be described in detail with reference to the drawings. Each embodiment described below presents a general or specific example. The numerical values, shapes, materials, elements, the arrangement and connection of the elements, steps, the processing order of the steps etc., shown in the following one or more embodiments are mere examples, and do not limit the scope of the present disclosure. Accordingly, among the elements in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, elements may be assigned with ordinal numbers such as “first”, “second”, and “third”. These ordinal numbers are given to elements in order to distinguish the elements from each other, and thus do not necessarily correspond to an order that has intended meaning. These ordinal numbers may be substituted, newly assigned, or removed as appropriate.

In the present disclosure, communication refers to a process whereby one user encodes a stimulus representing information or a sensation to be communicated into a communication medium, through which another user receives presentation of the stimulus via the communication medium and perceives the information or sensation to be communicated. In the present disclosure, a stimulus does not mean “a stimulus that gives a shock”, but only means “something that acts on a sensory organ”, and there is no particular limitation on the manner or degree of action on the sensory organ.

### Embodiment

### Overview

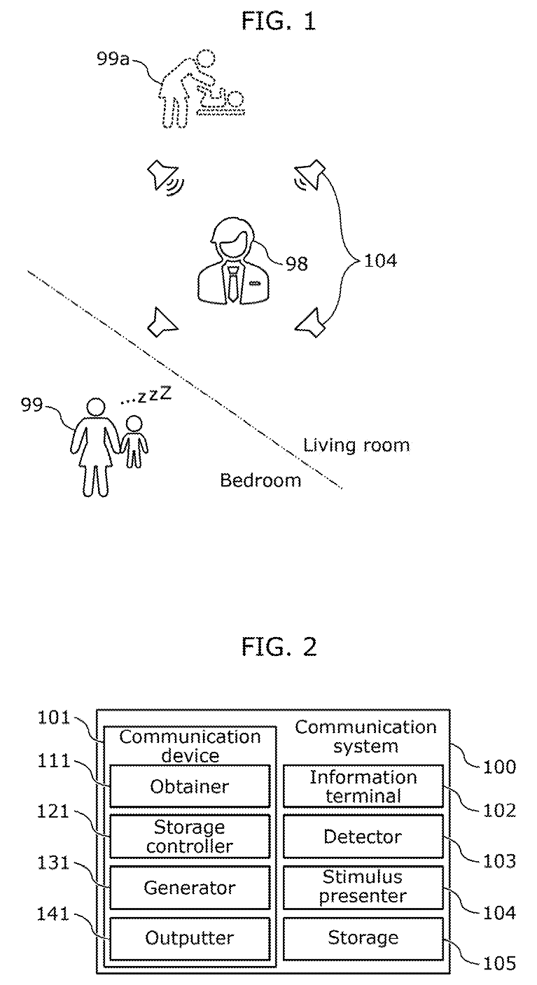

First, an overview of a communication system according to the embodiment will be described. FIG. 1 is a diagram for explaining an example of use of a communication system according to an embodiment of the present disclosure. FIG. 1 illustrates first user 98 who is a target recipient of communication to whom a stimulus from stimulus presenter 104 is presented by communication system 100 (see FIG. 2 to be described later), and second user 99 who is a target user who is a source of communication whose activity is estimated from the stimulus perceived by first user 98 through the presentation of the stimulus. In the present embodiment, communication from second user 99 to first user 98 is performed through the presentation of the stimulus.

In the present embodiment, communication system 100 presents a stimulus to first user 98 based on information about second user 99, thereby causing first user 98 to estimate the activity of second user 99 and perform communication. Here, unless otherwise specified, communication system 100 will be described mainly with an example using an auditory stimulus as the stimulus to be presented for communication, but the stimulus to be presented for communication is not limited to an auditory stimulus, and may be a stimulus to any sense as long as it can stimulate at least one of the five senses of first user 98, such as a visual stimulus, a tactile stimulus, or an olfactory stimulus. In the present embodiment, the stimulus for communication is presented as a stimulus arriving from the position of second user 99 as viewed from first user 98 toward the position of first user 98. Stated differently, a direction may be imparted to the presentation of the stimulus for communication. For example, in the case of an auditory stimulus, an acoustic technology known as spatial audio or three-dimensional audio may be used. Alternatively, simply, if one or more stimulus presenters 104 corresponding to the direction of the position of second user 99 as viewed from first user 98 from among two or more stimulus presenters 104 is used, the same effects can be obtained without special spatial stimulus technology.

Similarly, for visual stimuli, tactile stimuli, and olfactory stimuli, if special spatial stimuli can be performed due to technological advances or the emergence of derivative new technologies, such technologies may be used to present the stimuli with a direction, or one or more stimulus presenters 104 corresponding to the direction of the position of second user 99 as viewed from first user 98 from among two or more stimulus presenters 104 may be used to present the stimuli with a direction.

As illustrated in FIG. 1, here, second user 99 is a mother and child, and first user 98 is a father. At the time when the stimulus for communication is presented, the mother and child are sleeping in the bedroom, and the father has finished work outside the home, has returned home, and has just reached the living room. In such a situation, communication system 100 presents a stimulus generated at a position where second user 99, i.e., the mother and child, performed an activity in the past or is scheduled to perform an activity in the future. Such stimuli include, for example, in the case of auditory stimuli, walking sounds of second user 99, sounds emitted by toys when second user 99 plays using the toys, sounds of second user 99 preparing meals in the kitchen, operating sounds of equipment used by second user 99 for performing housework, and environmental sounds that occur around the position of second user 99 and that second user 99 hears. Stated differently, the term “position” in the phrase “stimulus generated at a position where second user 99 performed an activity in the past or is scheduled to perform an activity in the future” corresponds to an area having a

certain range that includes even the sources of generation of environmental stimuli (environmental sounds) that second user 99 perceives (hears).

By causing first user 98 to perceive stimuli generated by second user 99 herself or at sources around second user 99 with a time-series shift, first user 98 can sense presence 99a of second user 99 in a different time series. Stated differently, communication system 100 can communicate presence 99a of second user 99 to first user 98. From that presence 99a, first user 98 can estimate the situation of second user 99, and even in different time series, communication can be made from second user 99 to first user 98 via presence 99a according to the situation of second user 99, making it possible to use this as a new form of communication via communication of presence 99a.

Note that applications of communication system 100 are not limited to the example illustrated in the drawing in which first user 98 at home can sense presence 99a of second user 99 at the same home; for example, applications are also envisioned in which first user 98 in a building other than the home can sense presence 99a of second user 99 at home. As one example, communication system 100 may be configured such that a father (first user 98) at a location where he is living alone for work can sense presence 99a of a mother and child (second user 99) at home. In such cases, initial settings may be performed to match the space between the home and the location where the person is living alone for work.

### Structure

Hereinafter, a configuration of communication system 100 according to the present embodiment will be described with reference to FIG. 2. As illustrated in FIG. 2, communication system 100 includes communication device 101, information terminal 102, detector 103, stimulus presenter 104, and storage 105.

Communication device 101 is a device that performs communication processing by controlling stimulus presentation using stimulus presenter 104 and is, for example, an information processing server realized by an edge server or a cloud server. Communication device 101 uses a processor and memory and exhibits the functions of each functional element described below by executing a predetermined program stored in the memory. Communication device 101 includes four functional units: obtainer 111, storage controller 121, generator 131, and outputter 141. Obtainer 111 is a functional element that has five functions: a first obtainer, a second obtainer, a third obtainer, a fourth obtainer, and a fifth obtainer.

The first obtainer is a function for obtaining first position information indicating the position of first user 98. By communicating via a communication module with information terminal 102 of first user 98 and detector 103 capable of sensing first user 98, the first obtainer obtains first position information indicating the position of first user 98 from information terminal 102 and detector 103. The position granularity of first user 98 may be set as appropriate. For example, in the present embodiment in which both first user 98 and second user 99 are at the same home and a stimulus is presented to first user 98, the position granularity of first user 98 may be which room first user 98 is in within the home, or where first user 98 is within that room. Alternatively, when first user 98 is at a location where he is living alone for work and second user 99 is at home, the position granularity of first user 98 may be whether first user 98 is at the location where he is living alone for work or not.

The second obtainer is a function for obtaining second position information indicating the position of second user 99. By communicating via a communication module with information terminal 102 of second user 99 and detector 103 capable of sensing second user 99, the second obtainer obtains second position information indicating the position of second user 99 from information terminal 102 and detector 103.

The third obtainer is a function for obtaining second user information regarding the activity of second user 99. By communicating via a communication module with a device related to the activity of second user 99 (not illustrated), information terminal 102 of second user 99, or detector 103 capable of sensing second user 99, the third obtainer obtains second user information from the device, information terminal 102, and detector 103.

The fourth obtainer is a function for obtaining a time at which the second position information and the second user information are obtained. When the second position information and the second user information are obtained, the fourth obtainer obtains the time from a time server by communicating with the time server or the like via a communication module.

The fifth obtainer is a function for obtaining a specified time specified by first user 98. By communicating via a communication module with information terminal 102 of first user 98, the fifth obtainer obtains the specified time input by first user 98 from a user interface for time specification implemented in information terminal 102.

Information terminal 102 is an information processing terminal, such as a smartphone, tablet terminal, or personal computer (PC). Information terminals 102 are used by first user 98 and second user 99, respectively. Information terminal 102 includes sensors such as a global positioning system (GPS) for measuring position information and sensors capable of sensing the owner’s state and the like and is also used for obtaining second user information (described later) by sensing.

Detector 103 is a sensor installed at home for sensing second user 99, or a wearable sensor worn by second user 99.

Storage controller 121 is a controller that stores information in storage 105 and reads out information stored in storage 105. Storage controller 121 stores the obtained second position information, second user information, and time in association with each other in storage 105. Storage controller 121 designates and reads out a portion of the second user information stored in storage 105, thereby providing the portion of the second user information for data generation, so that a stimulus for communication to first user 98 is presented based on the portion of the second user information.

Storage 105 is a storage device that stores a plurality of stimulus candidates (here, auditory stimulus candidates) in association with information indicated in second user information. Information stored in storage 105 will also be described later together with the explanation of the determination of the stimulus based on second user information.

Generator 131 is a functional element that generates data that reproduces an activity of second user 99. Here, the data is data that, when output to stimulus presenter 104, presents a stimulus for reproducing the activity of second user 99. The data is information that designates stimulus presenter 104 and the stimulus to be presented from stimulus presenter 104, such that, based on the portion of the second user information read out by storage controller 121, a stimulus for communication according to the second user information is presented. Stated differently, generator 131 determines the stimulus to be presented based on the data to be generated. Determination of the stimulus based on second user information will be described later.

Outputter 141 outputs control information and transmits the control information to stimulus presenter 104 such that the stimulus is presented based on the data generated by generator 131. Stated differently, outputter 141 controls stimulus presenter 104 using the control information.

When stimulus presenter 104 presents an auditory stimulus as a stimulus as in the present embodiment, a loudspeaker may be used. Examples of such loudspeakers include televisions, stereos, headphones, smart speakers, lighting devices with integrated speakers, smartphones, tablets, and other audio output devices. However, when the loudspeaker used as stimulus presenter 104 imparts directionality to the presentation of the stimulus, at least two or more loudspeakers may be used. For example, as illustrated in FIG. 1, in order to present the stimulus such that the auditory stimulus arrives from the relative direction of the relative position of the position of second user 99 with respect to the position of first user 98, the auditory stimulus is presented by stimulus presenter 104 corresponding to the relative direction among the four stimulus presenters 104 (in the case of spatial audio, by some of stimulus presenters 104 corresponding to the relative direction), and presence 99a of second user 99 is communicated.

As already mentioned, the stimulus presented by stimulus presenter 104 may be any one of a visual stimulus, a tactile stimulus, or an olfactory stimulus, in addition to an auditory stimulus. Therefore, a device appropriate for the type of stimulus to be presented may be used as stimulus presenter 104. In particular, when the stimulus presented by the output of data is a visual stimulus, the stimulus may be presented by a virtual character (also known as an avatar) that is an abstraction of second user 99. The virtual character can change posture and facial expression in a visual stimulus such as a video. Such posture and facial expression correspond to the posture and facial expression of second user 99, and the posture and facial expression of second user 99 may be defined in the motion information of the second user information that is obtained.

Determination of Second User Information and Stimulus for Communication

Hereinafter, second user information obtained by the third obtainer described above and determination of a stimulus to be presented for communication based on the second user information will be described.

Second user information is information regarding the activity of second user 99 (activity information), as described above. Second user information includes at least one of vital information, motion information, or other information regarding activity.

Vital information indicates a vital sign of second user 99 and is used to determine a stimulus (i.e., generate data) by being used to estimate activity information or by being used alone. Vital information is obtained by sensing second user 99. Vital information is, for example, information indicating the body temperature of second user 99, and is used to estimate the exercise intensity of second user 99, that is, to estimate activity information regarding what exercise intensity activity second user 99 is performing. Alternatively, data may be generated to control devices that heat a space, such as an air conditioner or floor heater, using the body temperature indicated in the vital information, thereby heating the target space to which the position indicated in the second position information belongs and providing an abstracted temperature stimulus to the target space that signifies that second user 99 was present in the past.

Motion information indicates a motion of second user 99 and is used to determine a stimulus (i.e., generate data) by being used to estimate activity information or by being used alone. Motion information is obtained by capturing an image of second user 99 or the like. Using motion information, data is generated according to what motion second user 99 performed during a certain activity. For example, when the activity of second user 99 is preparing a meal, motion information can be used to generate data that produces a sound of cooking stir-fried food or data that produces a sound of cooking simmered food, depending on whether second user 99 was tossing a frying pan on a stove to stir-fry food or using a pot on the same stove to make simmered food.

Motion information also includes information indicating whether second user 99 was sleeping, playing, or using entertainment equipment such as a television with respect to the activity of spending time in the same living room, and the data to be generated can be changed accordingly.

Motion information may also include information on the surrounding environment. Stated differently, motion information may be used to change environmental sounds in the data to be generated, such as when a pet such as a dog is present around second user 99, when it is raining around second user 99, or when trees are rustling around second user 99.

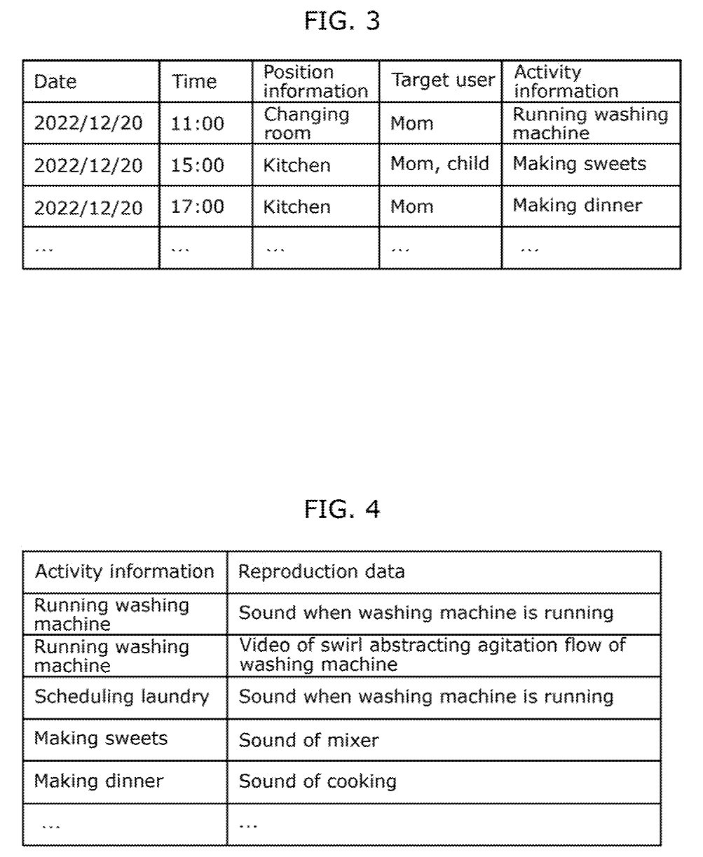

Information regarding other activities includes information indicating an activity of second user 99 as a comprehensive concept. For example, FIG. 3 is a diagram illustrating an example of information stored in storage according to the embodiment. As illustrated in FIG. 3, information stored in storage 105 by storage controller 121 includes information regarding date information including time, second position information, and information indicating an activity as a comprehensive concept (“activity information” in the figure), and information identifying second user 99 (“target user” in the figure) that is associated with the second position information and the information indicating an activity as a comprehensive concept. While accumulating such information, data is generated from information indicating an activity as a comprehensive concept. At that time, vital information and motion information are used to modify data based on information indicating an activity as a comprehensive concept, such as by partially changing the data to be generated or replacing the data to be generated using vital information and motion information.

To generate data from information indicating an activity as a comprehensive concept, for example, generative AI may be used to generate data to be reproduced by stimulus presenter 104 that designates a stimulus emitted by a user performing a certain activity or perceived by a user performing a certain activity. Alternatively, data conforming to information indicating an activity as a comprehensive concept may be read out and generated by referencing a database that associates a plurality of preset sets of information indicating an activity as a comprehensive concept with data consisting of stimulus presenter 104 and an aspect of a stimulus to be presented (stimulus presentation conditions).

FIG. 4 illustrates an example of a database according to an embodiment of the present disclosure. As illustrated in FIG. 4, in the database, data is set to be associated with each of items of information indicating an activity as a comprehensive concept. Corresponding data is then identified and read out based on information indicating an activity as a comprehensive concept in the obtained second user information. As a result, data can be generated from information indicating an activity as a comprehensive concept. In the example in the figure, when information indicating an activity as a comprehensive concept is “running the washing machine”, data for causing an auditory stimulus device as stimulus presenter 104 to output “sound when the washing machine is running” so as to reproduce a stimulus generated by operation of equipment related to the activity (i.e., the washing machine) is associated with the information. The sound here is not an actual recorded sound, but rather a general sound, in other words, an abstracted sound, as the sound when the washing machine is running.

When information indicating an activity as a comprehensive concept is “running the washing machine”, data for causing a visual stimulus device as stimulus presenter 104 to output “video of a swirl abstracting the agitation flow of the washing machine” is associated with the information.

In this manner, when there are a plurality of items of data generated based on information that indicate an activity as a comprehensive concept and are associated with different types of stimuli (here, a visual stimulus and an auditory stimulus) to be presented when output to stimulus presenter 104, both of these may be output to simultaneously present the stimuli.

Information indicating an activity as a comprehensive concept related to the washing machine is exemplified by two items: “running the washing machine” and “scheduling laundry”. These differ between an activity of second user 99 who ran the washing machine in the past and an activity of second user 99 who scheduled laundry (i.e., set a timer) so that the washing machine will run in the future. Stated differently, two patterns of activities of second user 99 are defined for the activity of operating the washing machine: past and future. In such a case, the time at which the washing machine operates is obtained as the time by the fourth obtainer.

First user 98 can specify a specified time in advance, and data generated from second user information associated with a time corresponding to this specified time is output, whereas data generated from second user information associated with a time not corresponding to the specified time is not output. By doing so, first user 98 can specify and reproduce only the data for which presence 99a is desired to be perceived in time series from among the plurality of items of data. The specified time may be a binary choice of past or future, or may allow specification of a period, such as a period from what time to what time in the past or a period from what time to what time in the future. As a concept different from the specified time, a start time may be settable. The start time can be input into the system by the same means as the setting of the specified time. This start time is, for example, one that inhibits output of data until the start time is reached. If such a setting is possible, it is preferable because data can be output at a timing preferred by first user 98.

When a plurality of data can be output from the second user information as described above, data based on second user information related to activities of second user 99 that are routinely performed and data based on second user information related to activities of second user 99 that are uniquely performed may be distinguishable. For example, second user information can be distinguished by extracting information such as past activity information through statistical processing. If second user information can be distinguished, it becomes possible to implement priority-based processing such that one of them is preferentially used for generation and output of data. For example, when second user information based on activities that second user 99 does not usually perform is included, by preferentially generating and outputting data of such second user information, first user 98 has the advantage of being able to easily perceive presence 99a of second user 99 that differs from usual.

### Operations

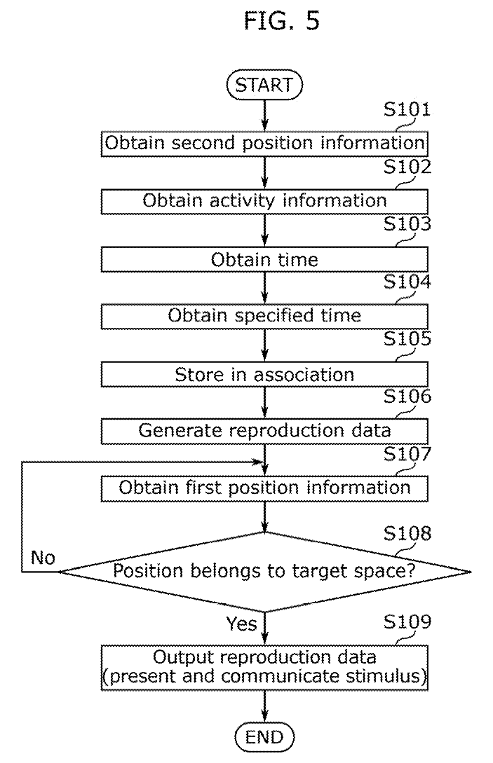

Next, operations of communication system 100 described above, particularly operations of communication device 101, will be described with reference to FIG. 5. FIG. 5 is a flowchart illustrating an operation example of a communication device according to the embodiment.

When operations of communication system 100 are started, first, obtainer 111 obtains second position information by communicating with information terminal 102 and detector 103 via a communication module (second obtaining step S101). Obtainer 111 further obtains second user information (activity information) by communicating with a device, information terminal 102, and detector 103 via a communication module (third obtaining step S102). Obtainer 111 further obtains a time by communicating with a time server via a communication module (fourth obtaining step S103). Obtainer 111 further obtains a specified time by communicating with information terminal 102 via a communication module (fifth obtaining step S104). Second obtaining step S101, third obtaining step S102, fourth obtaining step S103, and fifth obtaining step S104 need not be performed in this order, and may be performed in an order different from that in FIG. 5 or may be performed in parallel.

Storage controller 121 stores the second position information, second user information, and time in association with each other in storage 105 (storage step S105).

Generator 131 causes a set of second position information and second user information associated with a time corresponding to the specified time to be read out from among a plurality of sets each including a combination of second position information, second user information, and a time that are associated with each other and stored in storage 105, and generates data based on the read second user information (generation step S106). The generated data has a position specified by the second position information associated with the original second user information. For example, when the position indicated in the second position information is the kitchen and the information indicating an activity as a comprehensive concept indicated in the second user information is making sweets, the “sound of the mixer” illustrated in FIG. 4 is specified at the position of “kitchen”. Specifying such a position also leads to specifying the target space to which the position belongs. When the data is output, stimulus presenter 104 capable of presenting a stimulus in the target space is designated. With this, when the data is output, a stimulus is presented in the target space.

Subsequently, obtainer 111 obtains first position information by communicating with information terminal 102 and detector 103 via a communication module (first obtaining step S107). First obtaining step S107 may be performed before any one of second obtaining step S101, third obtaining step S102, fourth obtaining step S103, and fifth obtaining step S104, or may be performed in parallel with any one of these.

When the position indicated in the obtained first position information belongs to the target space to which the position designated in the data belongs (Yes in step S108), that is, when the position indicated in the first position information matches the position indicated in the second position information in the sense that they belong to the target space, the data is output by outputter 141 and a stimulus is presented, thereby communicating presence 99a (output step S109). However, when the position indicated in the obtained first position information does not belong to the target space to which the position designated in the data belongs (No in step S108), that is, when the position indicated in the first position information does not match the position indicated in the second position information in the sense that they belong to the target space, the data is not output by outputter 141. In that case, the process returns to first obtaining step S107, and obtainer 111 obtains the first position information again.

Through such operations, for example, it becomes possible for first user 98 to perceive, as presence 99a, that second user 99 performed an activity at a destination position within a period of a specified time while first user 98 moves around inside the home after returning home.

Presence 99a may be perceived based on such a positional relationship between first user 98 and second user 99, or alternatively, second user 99 may be able to set the timing at which data is output as described below.

First, second user 99 inputs information regarding output timing together with the second position information and the second user information, for example, via information terminal 102. When the timing at which data should be output, as indicated by the information regarding the input output timing, is reached, the data is output at the position where first user 98 is located.

The information regarding output timing may be, for example, conditional information for the position indicated in the first position information, such that output occurs when the position indicated in the first position information becomes a position belonging to the kitchen for the first time on that day. Alternatively, the information regarding output timing may be conditional information for time, such that output occurs when a set time preset by second user 99 is reached.

In the manner described above, first user 98 can perceive presence 99a of second user 99 through the presentation of a stimulus for communication, and even when life cycles are misaligned, communication can be made from second user 99 to first user 98 according to the situation of second user 99, making it possible to use this as a new form of communication. This enables more appropriate communication based on information about second user 99.

### Other Embodiments

While one or more exemplary embodiments have been described above, the present disclosure is not limited to the above-described one or more embodiments.

For example, in the communication system described in the above embodiment, an example using a virtual character was described with respect to visual stimuli, but for example, a stimulus may be presented by the output of data indicating the activity of the second user using the target space, that is, the activity of using the space, by simply having a light source emit light in a color assigned to each second user using a color-adjustable light source (ceiling light or dedicated light source device) provided in each target space.

For example, while an example has been described in which second user 99 is a person, second user 99 may be a living being other than a person, such as a pet.

For example, the communication system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the communication device.

In the above one or more embodiments, processing executed by a specific processor may be executed by another processor. Moreover, the order of the plurality of processes may be changed, or the plurality of processes may be executed in parallel.

Moreover, in the above one or more embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each element may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, an apparatus, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as a communication method executed by a computer, or may be implemented as a program for causing a computer to execute a communication method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

### INDUSTRIAL APPLICABILITY

The present disclosure is applicable in communication based on information about a second user.

1. A communication method for communicating to a first user, the communication method comprising:
obtaining and storing second position information indicating a position of a second user different from the first user and activity information indicating an activity of the second user, the second position information and the activity information being stored in association with each other;
generating, based on the activity information, data that reproduces the activity of the second user, the data being data that, when output to a stimulus presenter, presents a stimulus for reproducing and communicating the activity of the second user; and
outputting, in a target space to which the position indicated in the second position information belongs, the data generated based on the activity information associated with the second position information, to the stimulus presenter.

2. The communication method according to claim 1, further comprising:
obtaining first position information indicating a position of the first user, wherein
the outputting is executed when the position indicated in the first position information becomes a position that belongs to the target space.

3. The communication method according to claim 1, wherein
the outputting is executed at a set time set in advance by the second user.

4. The communication method according to claim 1, wherein
the obtaining and storing includes obtaining, in addition to the second position information and the activity information, a time of obtainment of the second position information and the activity information, and storing the second position information, the activity information, and the time in association with each other.

5. The communication method according to claim 4, further comprising:
obtaining a specified time specified by the first user, wherein
the outputting includes:
outputting, to the stimulus presenter, the data generated based on the activity information associated with the time corresponding to the specified time; and
excluding, from output to the stimulus presenter, the data generated based on the activity information associated with the time not corresponding to the specified time.

6. The communication method according to claim 1, wherein
the data is associated with a type of stimulus to be presented when output to the stimulus presenter, and
the outputting includes simultaneously outputting a plurality of items of the data generated based on a same item of the activity information, the plurality of items of the data being associated with different types of stimuli to be presented when output to the stimulus presenter.

7. The communication method according to claim 1, wherein
the data is data that, when output to the stimulus presenter, presents the stimulus for reproducing a future activity of the second user.

8. The communication method according to claim 1, wherein
the data is data that, when output to the stimulus presenter, presents the stimulus for reproducing a past activity of the second user.

9. The communication method according to claim 1, wherein
the generating includes generating the data based on the activity information by referencing a database that associates the activity information with the data using the activity information.

10. The communication method according to claim 1, wherein
in the outputting, the stimulus is presented from the stimulus presenter using a virtual character that is an abstraction of the second user.

11. The communication method according to claim 1, wherein
the generating includes generating the data that, when output to the stimulus presenter, reproduces the stimulus generated by an operation of a device related to an activity indicated in the activity information.

12. The communication method according to claim 1, wherein
the activity information includes at least one of vital information indicating a vital sign of the second user or motion information indicating a motion of the second user.

13. A communication device for communicating to a first user, the communication device comprising:
a storage controller that obtains second position information indicating a position of a second user different from the first user and activity information indicating an activity of the second user, and stores the second position information and the activity information in association with each other;
a generator that generates, based on the activity information, data that reproduces the activity of the second user, the data being data that, when output to a stimulus presenter, presents a stimulus for reproducing and communicating the activity of the second user; and
an outputter that outputs, in a target space to which the position indicated in the second position information belongs, the data generated based on the activity information associated with the second position information, to the stimulus presenter.

14. A non-transitory computer-readable recording medium for use in a computer, the recording medium having a computer program recorded thereon for causing the computer to execute the communication method according to claim 1.
